(19) United States
(12) Patent Application Publication
(10) Pub. No.: US 2008/0289928 A1
(43) Pub. Date: Nov. 27, 2008

(54) Ball Screw Drive Having Overload Clutch

(75) Inventors: Simon Abraham, Berlin (DE); Michael Beyer, Berlin (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, Munich (DE)

(21) Appl. No.: 12/092,708

(22) PCT Filed: Nov. 1, 2006
(86) PCT No.: PCT/EP06/68014

§ 371 Date: May 6, 2008

(30) Foreign Application Priority Data
Nov. 8, 2005 (DE) 10 2005 053 896.7

(51) Int. Cl. F16D 21/04

(52) U.S. Cl. 192/110 R

(57) ABSTRACT

A ball screw drive has a housing in which a spindle nut is arranged on a ball screw spindle. An overload clutch disengages when a force acting on the ball screw spindle reaches a release force. A preloading device, with at least one adjusting member, can be set to a preloading force and acts on the overload clutch. A moveable pressure element is provided on which the preloading device can engage in order to transmit the preloading force to the overload clutch. The housing is of single-part design and the pressure element is disposed so as to slide on a housing face and on a peripheral face of the spindle nut.

The present invention relates to a ball screw with a housing in which a spindle nut is arranged on a ball screw spindle, with an overload clutch that trips on reaching a tripping force acting on the ball screw spindle, with a preloading device that can be set by means of at least one setting member to a preloading force and acts on the overload clutch, and with one moving thrust element that can be contacted by the preloading device in order to transmit the preloading force to the overload clutch.

A ball screw of this kind is known from DE 44 27 809. The ball screw described there has a housing made of two cylindrical hollow bodies that are pushed over the spindle nut. Adjusting nuts provided on the end faces act via cup springs on thrust bearings that are supported on the spindle nut. On exceeding an admissible setting force or on reaching a tripping force, the spindle nut makes a movement relative to the element to be driven by compressing one of the cup spring arrangements and after a given deflection distance pushing one of the cylindrical hollow bodies relative to the other and tripping the overload clutch or allowing it to slip.

The design of the prior art is very complicated and requires a series of components that can move relative to one another and even a two-piece housing. An encapsulated configuration in the area of the overload clutch is therefore not possible. Further-more, the tripping force is essentially determined by the spring travels of the cup springs and the width of the gap between the housing halves and the spindle nut. The principal parameters for the tripping force are therefore difficult to determine and a precise setting of the same is hardly possible.

The object of the present invention is therefore to further develop a ball screw as mentioned at the beginning in such a way that the tripping force is then essentially dependent only on the adjustable preloading forces acting on the overload clutch.

The object is achieved according to the invention in that the housing is formed in one piece and the thrust element is arranged so that it slides along one surface of the housing and along one circumferential surface of the spindle nut.

With this design it is possible to set a preloading force via any setting member that is transmitted via a moving thrust element directly to the overload clutch without the housing parts having to move relative to one another. Furthermore, the design according to the invention permits an encapsulated configuration of the ball screw.

Further advantages can be derived from the features of sub-claims 2 to 11.

Two embodiments of the present invention are described below in greater detail by reference to the drawings.

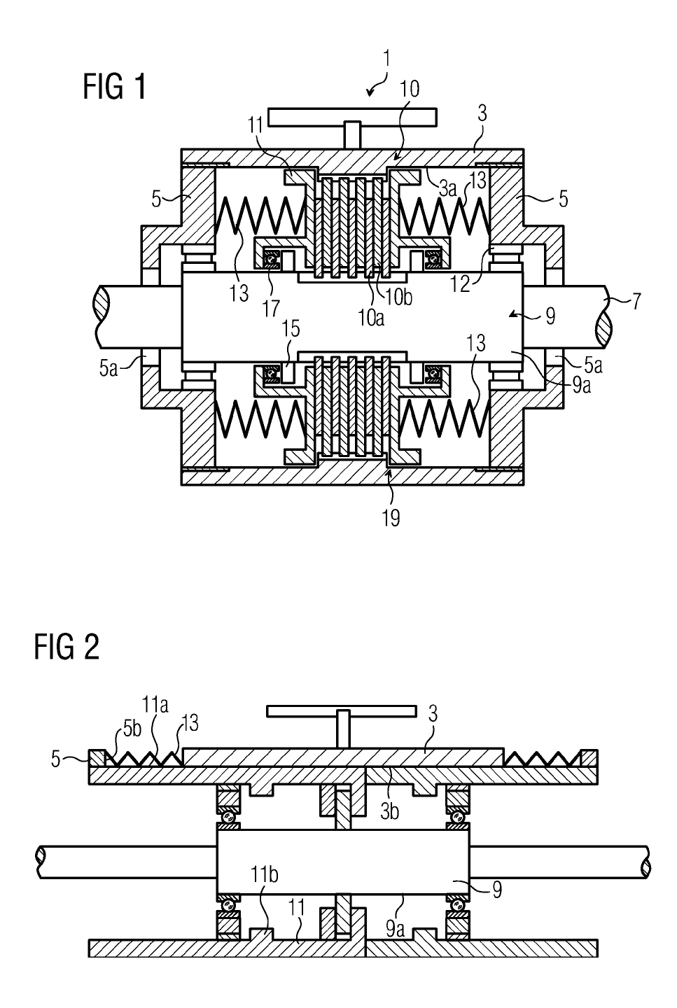

FIG. 1 shows a schematic view in longitudinal section through a ball screw with an overload clutch according to a first embodiment of the present invention;

FIG. 2 shows a schematic view in longitudinal section through a ball screw with an overload clutch according to a second embodiment of the present invention.

FIG. 1 shows schematically a ball screw 1 with a one-piece housing 3 that is closed on each of two opposed end faces with a setting member 5 that in the present embodiment is preferably formed as an adjusting nut. The setting members 5 have a through opening 5a through which a ball screw spindle 7 is guided. In the area of the housing 3, the ball screw spindle 7 is surrounded by a spindle nut 9 on the circumferential surface 9a of which each setting member 5 is supported by a bearing 12 that in the present embodiment can take the form of a roller bearing or a radial-contact ball bearing with a clearance fit. In this way the spindle nut 9 cannot just turn in the housing 3 but can also move axially. Arranged between the spindle nut 9 and one inner side of the housing 3 is an overload clutch 10. In the present embodiment the overload clutch 10 is a multi-plate clutch with friction plates 10a of the housing 3 and friction plates 10b of the spindle nut 9.

The overload clutch 10 is limited by two thrust elements 11 that in the present embodiment take the form of a thrust ring. Arranged between each setting member 5 and the thrust ring 11 is a preloading device 13 that applies preloading forces to the thrust elements 11, depending on each setting member 5. In the present embodiment the preloading device 13 is preferably a spring element, in particular a compression spring, such as for example a helical or cup spring. The preloading forces of the preloading device 13 lie slightly above a tripping force of the overload clutch 10. The preloading force Fk and hence also the tripping force Fs can be set by turning one or both setting members 5. In a preferred embodiment, both setting members 5 are turned by an equal amount so that equal preloading forces occur. An unequal setting, on the other hand, allows directional dependencies of components to be compensated. Since the preloading forces Fk cancel one another out in the middle position, the spindle nut 9 together with the multi-plate clutch 10 and the thrust element 11 can be moved relatively easily axially in the housing 3.

The function of the overload clutch 10 is described below:

When the ball screw spindle 7 is driven, the spindle nut 9 transforms a torque of the ball screw spindle 7 into an axial force F, as the preloaded overload clutch 10 prevents the spindle nut 9 from turning relative to the housing 3.

The axial force F generated in this way then shifts the spindle nut 9 in the corresponding functional direction relative to the housing 3 and the overload clutch 10. In view of the preferably symmetrical design of the ball screw, only the functional direction shown in FIG. 1 to the left-hand side is described below. The spindle nut 9 moves relative to the housing 3 until the spindle nut 9 contacts an axial-contact ball bearing 17 of the thrust element 11 on the left-hand side with a left-hand stop 15. The spindle nut 9 then carries the overload clutch 10 and the thrust element 11 along, said thrust element 11 sliding along one inner surface of the housing 3a until the thrust element 11 on the right-hand side in FIG. 1 contacts a right-hand shoulder 19 in the housing 3.

The overload clutch 10 remains in this position during an operating process. Although the preloading force Fk in the overload clutch 10 is hereby reduced by the amount of the force F, it remains sufficiently large at all times to prevent a slipping of the overload clutch 10. In view of the fact that the right-hand preloading device 13 presses the thrust element 11 against the right-hand shoulder 19, the preloading force Fk is now determined only by the preloading force (Fv1) of the left-hand preloading device 13 and the axial force F (Fk=Fv1−F).

If the drive contacts an obstacle, the axial force F increases. As a result, the preloading force Fk in the overload clutch 10 is reduced and at the same time the torque in the overload clutch 10 is increased. If a predetermined tripping force Fs is reached, the overload clutch 10 slips.

FIG. 2 shows a second illustrative embodiment. The second embodiment also operates with the functional principle described with reference to the first embodiment. The design of the second embodiment differs from that of the first embodiment only in that openings are provided in the one-piece housing 3 and the thrust element 11 contacts an inner surface of the housing 3b with a flat section 11a, with each flat section 11a having openings in the area of the housing inner surface 3b through which the thrust elements 11 are guided on alternate sides with shoulders 11b and are supported on the circumferential surface 9a of the spindle nut 9. Each setting member 5 has a flange 5b. The preloading device 13 is arranged between this flange 5b and the housing 3.

1-11. (canceled)

12. A ball screw device, comprising:
a housing formed in one piece;
a spindle nut disposed on a ball screw spindle in said housing, said spindle nut having a peripheral surface;
an overload clutch configured to trip when a force acting on said ball screw spindle reaches a given tripping force;
a preloading device to be set, by way of at least one setting member, to a preloading force and acting on said overload clutch; and
at least one moving pressure element to be contacted by said preloading device for transmitting the preloading force to said overload clutch, said at least one pressure element being disposed to slide along a surface of said housing and along said peripheral surface of said spindle nut.

13. The ball screw device according to claim 12, wherein said pressure element is a thrust ring limiting said overload clutch.

14. The ball screw device according to claim 12, wherein said preloading device has two compression springs, each assigned to a respective setting member.

15. The ball screw device according to claim 12, which comprises a bearing disposed between each said setting member and said peripheral surface of said spindle nut.

16. The ball screw device according to claim 15, wherein said bearing is a roller bearing.

17. The ball screw device according to claim 15, wherein said bearing is a radial-contact ball bearing.

18. The ball screw device according to claim 12, wherein said overload clutch is a multi-plate clutch.

19. The ball screw device according to claim 18, wherein said multi-plate clutch comprises at least one friction plate of said spindle nut and at least two friction plates of said housing.

20. The ball screw device according to claim 12, wherein said preloading device is disposed inside said housing.

21. The ball screw device according to claim 12, wherein each said pressure element has a flat section contacting an inner surface of said housing, each flat section has openings in an area of the housing inner surface through which said pressure elements are guided on alternate sides with shoulders and are supported on said peripheral surface of said spindle nut.

22. The ball screw device according to claim 21, wherein each said setting member has a flange and said preloading device is disposed between said flange and said housing.
